(19) United States
(12) Patent Application Publication
(10) Pub. No.: US 2025/0192484 A1
(43) Pub. Date: Jun. 12, 2025

(54) CHARGING CABLE

(71) Applicant: XOOPAR LIMITED, New Territories (HK)

(72) Inventor: Ka Yin Tsui, New Territories (HK)

(21) Appl. No.: 18/679,668

(22) Filed: May 31, 2024

(30) Foreign Application Priority Data
Dec. 6, 2023 (CN) 202323335175.1

(51) Int. Cl. H01R 13/717; H01R 13/66; H02J 7/00

(52) U.S. Cl. CPC H01R 13/7175; H01R 13/6683; H02J 7/0047

(57) ABSTRACT

The invention discloses a charging cable, which comprises a longitudinal cable body, an input end and an output end which are electrically connected to two opposite ends of the cable body respectively, wherein the output end comprises a first housing, a first circuit board, an indicating device used for indicating a quick-charging state or a slow-charging state, and at least one output connector. The indicating device and each output connector are respectively connected with the first circuit board; the first circuit board is electrically connected with the cable body; and the first housing encloses the first circuit board, the indicating device and a portion of each output connectors. The indicating device at the output end of the charging cable can display a quick-charging state and a slow-charging state in the charging process, and it can be intuitively known whether the electronic equipment is in the quick-charging state.

### CROSS REFERENCE TO RELATED APPLICATIONS

The present application claims the benefit of Chinese Patent Application No. 202323335175.1 filed on Dec. 6, 2023, the contents of which are incorporated herein by reference in their entirety.

### BACKGROUND OF THE INVENTION

### 1. Technical Field

The invention relates to the technical field of electronic accessories, in particular to a charging cable.

### 2. Description of Related Art

At present, charging cables/data cables on the market are often used to connect between power supplies (such as power banks) and electronic devices (mobile phones, tablets, etc.) to charge electronic devices or achieve data transmission. Current charging methods comprise quick-charging and slow-charging. However, in a quick-charging process of the existing electronic equipment, a user cannot intuitively know whether the electronic equipment is in a quick-charging state, and a technician cannot get the quick-charging state in real time, so that the electronic equipment is prone to overcharging, and even suffers from power damage, resulting in poor quick-charging safety of the electronic equipment.

### BRIEF SUMMARY OF THE INVENTION

The technical problem to be solved by the invention is to provide an improved charging cable aiming for at least one defect of the background technology.

The technical scheme adopted by the invention to solve the technical problems is as follows: a charging cable comprises a longitudinal cable body, an input end and an output end which are electrically connected with the two opposite ends of the cable body respectively, wherein the output end comprises a first housing, a first circuit board, an indicating device for indicating a quick-charging state or a slow-charging state, and at least one output connector; the indicating device and each output connector are respectively connected with the first circuit board; the first circuit board is electrically connected with the cable body; and the first housing surrounds the first circuit board, the indicating device and a portion of each output connector.

Preferably, the indicating device comprises an indicator light unit, and the indicator light unit is used to indicate a quick-charging state and a slow-charging state.

Preferably, the indicator light unit comprises a first indicator light and a second indicator light which are respectively connected with the first circuit board; in the quick-charging state, the first indicator light is turned on, and the second indicator light is turned off; in the slow-charging state, the second indicator light is turned on, and the first indicator light is turned off.

Preferably, the charging cable further comprises a light turning circuit and a current-voltage detection circuit;

The light turning circuit comprises a first light-emitting module and a second light-emitting module, wherein the first light-emitting module comprises the first indicator light, and the second light-emitting module comprises the second indicator light;

The current-voltage detection circuit comprises a control chip, and the control chip is respectively connected with the first light-emitting module and the second light-emitting module.

Preferably, the first housing is provided with at least one through hole; and all the output connectors and the cable body respectively through the through hole and partially inserted into the first housing.

Preferably, the first housing is provided with a light-transmitting portion.

Preferably, the light-transmitting portion is a light-transmitting hole.

Preferably, the charging cable also comprises a decorative member capable of transmitting light, and the decorative member is at least partially arranged in the light-transmitting hole.

Preferably, the first housing comprises at least two connected housing unit.

Preferably, the output connector comprises at least one of a Micro-USB connector, a type-c connector, and an Apple Lightning Dock connector.

The charging cable at least has the following beneficial effects: the indicating device at the output end can display the quick-charging state and the slow-charging state in the charging process to a user, so that the user can intuitively know whether the electronic equipment is in a quick-charging state, and a technician can get a quick-charging state in real time.

### BRIEF DESCRIPTION OF THE SEVERAL VIEWS OF THE DRAWINGS

Brief description of that drawing the invention will now be further described by way of example with reference to the accompany drawings in which:

FIG. 1 is a schematic diagram of the overall structure of a charging cable according to an embodiment of the present invention;

FIG. 2 is an overall exploded structural diagram of the charging cable shown in FIG. 1;

FIG. 3 is an exploded structural diagram of the output end of the charging cable shown in FIG. 1;

FIG. 4 is a schematic view of FIG. 3 from another perspective;

FIG. 5 is a schematic diagram of an electrical connection structure of a charging cable according to an embodiment of the present invention;

FIG. 6 is a circuit structure diagram of a light turning circuit according to an embodiment of the present invention;

FIG. 7 is a circuit structure diagram of a current-voltage detection circuit according to an embodiment of the present invention.

### DETAILED DESCRIPTION OF THE INVENTION

In order to have a clearer understanding of the technical features, purposes and effects of the invention, the specific embodiments of the invention are described in detail with reference to the drawings. The charging cable described herein may also be understood as a data cable.

As shown in FIG. 1, a charging cable according to an embodiment of the present invention comprises a longitudinal cable body 1, an input end and an output end electrically connected to the two opposite ends of the cable body 1 respectively.

The output end comprises a first housing 31, a first circuit board 33, an indicating device for indicating a quick-charging state or a slow-charging state, and at least one output connector 3. The indicating device and all the output connectors 3 are respectively connected to the first circuit board 33. The first circuit board 33 is electrically connected to the cable body 1. The first housing 31 encloses the first circuit board 33, the indicating device and part of each output connector 3.

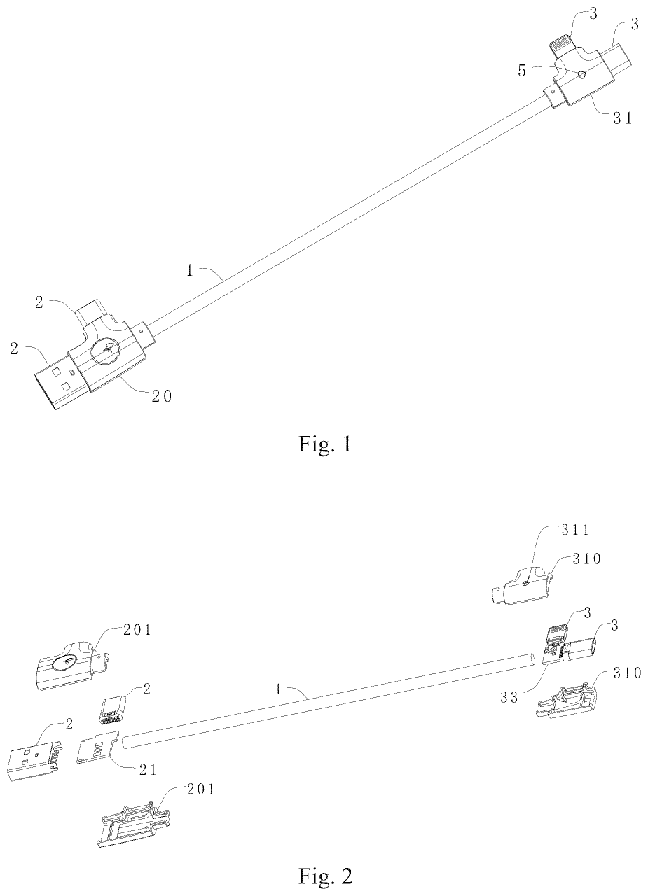

An output connector 3 can be a Micro-USB connector, a type-c connector, or an Apple Lightning Dock connector. For example, in the embodiment as shown in FIG. 1 and FIG. 2, the output end comprises two output connectors 3, and one of the output connectors 3 is a type-c connector and another is an Apple Lightning Dock connector. The two output connectors 3 are located on the same plane, and the extension directions of the interfaces are perpendicular to each other

The input end also comprises at least one input connector 2. As shown in FIG. 1 and FIG. 2, in an embodiment, the input end comprises two input connectors 2, and the two input connectors 2 are located on the same plane, and the extension directions of the interfaces are perpendicular to each other. One of the two input connectors 2 at the input end is a Micro-USB connector and another is a type-c connector, which more match the electronic products technology development. Of course, in other embodiments, the input end may also comprise two Micro-USB connectors or two type-c connectors. The distance between the two input connectors 2 of the input end is less than 3 cm, more preferably less than 2 cm.

The indicating device is used for indicating a quick-charging state or a slow-charging state. The quick-charging state and the slow-charging state may be defined by a voltage and/or a current passing through the cable body 1. The first circuit board 33 can detect the voltage and current passing through the cable body 1, so as to control the indicating device to indicate a quick-charging state or a slow-charging state to the user. For example, in an embodiment, when the current passing through the cable body 1 is higher than 200 mA, but the voltage passing through the cable body 1 is lower than 6 V, the indicating device can indicate a slow-charging state to the user; when the voltage passing through cable body 1 is higher than or equal to 6 V, the indicating device can indicate a quick-charging state to the user. In a specific application scenario, the user connects one of the input connectors 2 of the charging cable to a fast charger with an output voltage of 9 V, the fast charger is connected to the power supply, and one of the output connectors 3 of the charging cable is connected to an electronic device. And then, the indicating device at the output end indicates a quick-charging state to the user. User can intuitively know that the electronic equipment is in a quick-charging state, and technicians can get the quick-charging state in real time. For another example, user connects one of the input connectors 2 of the charging cable to a slow charger with an output voltage of 5V, the slow charger is connected to a power supply, and one of the output connectors 3 of the charging cable is connected to an electronic device. And then, the indicating device at the output end indicates a slow-charging state to the user. Therefore, the output voltage range of the device connected with the input end of the charging cable can be intuitively judged by using the indicating device.

To sum up, the invention at least has the beneficial effects that the indicating device at the output end can display the quick-charging state and the slow-charging state in the charging process to the user, so that the user can intuitively know whether the electronic device is in a quick-charging state, and the technician can get the quick-charging state in real time.

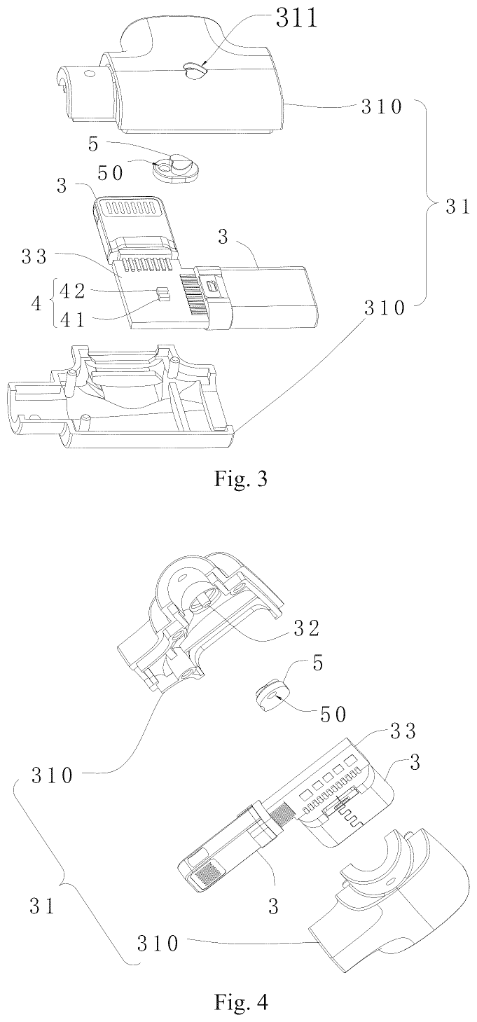

As shown in FIG. 3 and FIG. 4, in an embodiment, the indicating device is an indicator light unit 4, and the indicator light unit 4 is used to indicate a quick-charging state and a slow-charging state. That is, the indicator light unit 4 can send out at least two different light source signals, and the different light source signals respectively correspond to the quick-charging state and the slow-charging state, so as to intuitively display the quick-charging state and the slow-charging state in the charging process for the user.

Further, as shown in FIG. 3, in an embodiment, the indicator light unit 4 comprises a first indicator light 41 and a second indicator light 42. The first indicator light 41 and the second indicator light 42 can be distinguished by the wavelength of the light. For example, in an embodiment, the first indicator light 41 is a green light, and the second indicator light 42 is a white light. Of course, the first indicator light 41 and the second indicator light 42 may be distinguished from each other in other forms. In a quick-charging state, the first indicator light 41 is turned on and the second indicator light 42 is turned off. In a slow-charging state, the second indicator light 42 is turned on and the first indicator light 41 is turned off. Therefore, the user can intuitively determine the quick-charging state and the slow-charging state in the charging process through the first indicator light 41 and the second indicator light 42.

It can be understood that in other embodiments, the indicator light unit 4 can also indicate a quick-charging and a slow-charging by sending out a fast and slow flashing light signal through an indicator light, for example, in the quick-charging state, one indicator light of the indicator light unit 4 sends out a fast flashing light signal, and in the slow-charging state, one indicator light of the indicator light unit 4 sends out a slow flashing light signal.

As shown in FIG. 3, the first indicator light 41 and the second indicator light 42 are mechanically and/or electrically connected to the first circuit board 33 respectively. In the embodiment shown in FIG. 3, a first indicator light 41 and a second indicator light 42 are attached to the upper surface of the first circuit board 33. In other embodiments, one first indicator light 41 and one second indicator light 42 may be connected to the lower surface of the first circuit board 33, or one first indicator light 41 and one second indicator light 42 may be connected to the upper surface and the lower surface of the first circuit board 33, respectively.

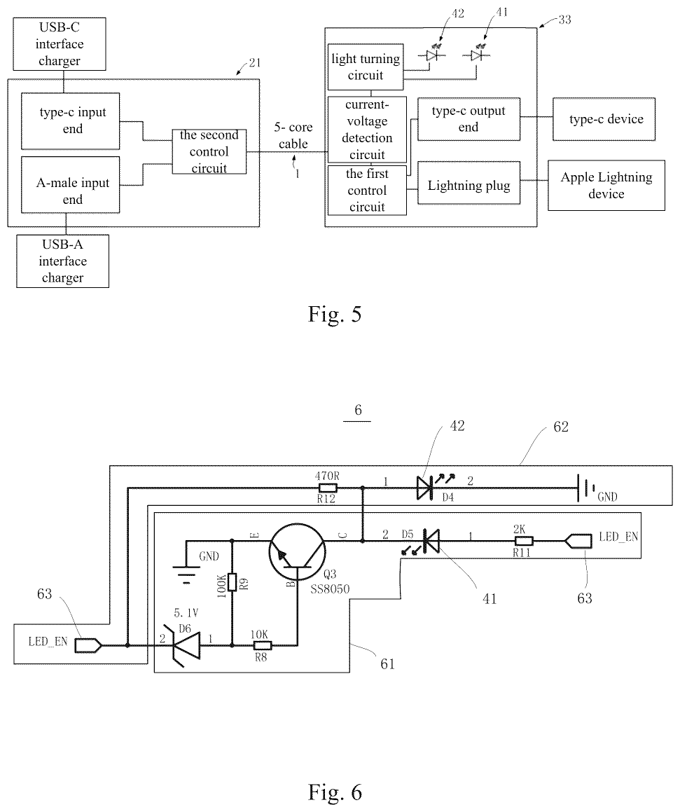

As shown in FIG. 5, in an embodiment, the charging cable further comprises a light turning circuit 6, and a current-voltage detection circuit 7 electrically connected to the light turning circuit 6. The turning circuit 6 and the current-voltage detection circuit 7 may be provided on the first circuit board 33 by printing or the like.

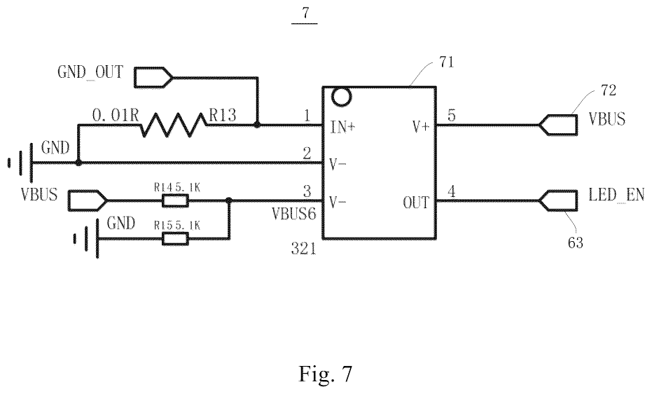

As shown in FIG. 6 and FIG. 7, in an embodiment, the light turning circuit 6 comprises a first light-emitting module 61 and a second light-emitting module 62, the first light-emitting module 61 comprises a first indicator light 41, and the second light-emitting module 62 comprises a second indicator light 42. The current-voltage detection circuit 7 comprises a control chip 71, and the control chip 71 is connected to the first light-emitting module 61 and the second light-emitting module 62 respectively.

The first indicator light 41 of the first light-emitting module 61 and the second indicator light 42 of the second light-emitting module 62 can respectively emit light signals under the control of the control chip 71. Specifically, the current-voltage detection circuit 7 can detect the current and voltage passing through the cable body 1, and when the current passing through the cable body 1 is lower than 200 mA, both the first indicator light 41 and the second indicator light 42 do not emit light. When the current passing through the cable body 1 is higher than 200 mA and the voltage is lower than 6 V, the control chip 71 controls the second indicator light 42 to emit light, and the first indicator light 41 does not emit light. and then, from the user's perspective, white light can be seen flashing, indicating a slow-charging state. When the current passing through the cable body 1 is higher than 200 mA and the voltage is higher than or equal to 6 V, the control chip 71 controls the first indicator light 41 to emit light and controls the second indicator light 42 not to emit light at the same time. And then, from the user's perspective, green light can be seen flashing, indicating a quick-charging state.

Specifically, as shown in FIG. 6, in an embodiment, the first light-emitting module 61 comprises a connection end 63 (the connection end 63 is an LED_EN end), a Zener diode D6, a transistor Q3 (numbered SS8050), a first resistor R8, a second resistor R9, a third resistor R11, and a first indicator light 41. The first indicator light 41 includes a light-emitting diode D5, the first end of the first resistor R8 and the first end of the second resistor R9 connected to the anode of the Zener D6, the second end of the first resistor R8 connected to the base of the transistor Q3, and the second end of the second resistor R9 connected to the emitter of the transistor Q3.The cathode of the light-emitting diode D5 is connected to the collector of the transistor Q3,The emitter of transistor Q3 and the second end of the second resistor R9 are grounded, the anode of light-emitting diode D5 is connected to the first end of the third resistor R11, and the second end of the third resistor R11 and the cathode of the Zener D6 are connected to the connection end 63.

The second light-emitting module 62 comprises a connecting end 63, a fourth resistor R12, and a second indicator light 42. The second indicator light 42 includes a light-emitting diode D4, the first end of the fourth resistor R12 is connected to the connection terminal 63, the second end of the fourth resistor R12 is connected to the anode of the light-emitting diode D4, and the cathode of the light-emitting diode D4 is grounded.

The first light-emitting module 61 is connected to the second light-emitting module 62.

Specifically, as shown in FIG. 7, in an embodiment, the current-voltage detection circuit 7 further comprises an input end 72 connected to the control chip 71, wherein the input end 72 is a VBUS end and is electrically connected to the cable body 1. The connection end 63 is also connected to the control chip 71. The current-voltage detection circuit 7 detects the current through a sampling resistor, and an operational amplifier is used as a comparator.

In the light turning circuit 6, the zener diode D6 is a zener diode with a forward voltage of 5.1V. The Zener diode D6 can keep the voltage stability after the reverse breakdown. In the current-voltage detection circuit 7, the voltage at the connection end 63 is lower than the voltage at the input end 72 by about 1 V. Therefore, when the voltage of the input end 72 is equal to or higher than 6 V, the connection end 63 outputs a voltage equal to or higher than 5.1 V, and the zener diode D6 is turned on. When the control chip 71 detects that the current is lower than or equal to 200 mA and the voltage of the input end 72 is higher than or equal to 6 V, the Zener diode D6 is turned on, and the transistor Q3 is turned on accordingly. And then, the cathode of light-emitting diode D5 and the anode of light-emitting diode D4 are at a low level, the first indicator light 41 is turned on and emits light, and the second indicator light 42 is turned off. On the contrary, when the voltage of the input end 72 is lower than 6 V, the Zener diode D6 is turned off and the transistor Q3 is turned off, the cathode of light-emitting diode D5 and the anode of light-emitting diode D4 are at a high level., the first indicator light 41 is turned off, and the second indicator light 42 is turned on and emits light.

When the current of the input end 72 is lower than 200 mA, both the first indicator light 41 and the second indicator light 42 are turned off.

As shown in FIG. 1 and FIG. 2, in an embodiment, the output end further comprises a first housing 31, and the first circuit board 33 and the indicating device are disposed in the first housing 31. The first housing 31 is provided with three through holes. The two output connectors 3 and the cable body 1 respectively through the through holes and partially extend into the first housing 31. Specifically, the type-c connector extends into the first housing 31 partially through the first through hole, the Apple Lightning Dock connector extends into the first housing 31 partially through the second through hole, and the cable body 1 extends into the first housing 31 partially through the third through hole. The three through holes are respectively located on three sides of the first housing 31, so that the cable body 1 and one of the output connectors 3 are arranged perpendicularly to each other, and the two output connectors 3 are also arranged perpendicularly to each other. Of course, the number of the through holes is not limited to three, but may be two or three or more depending on the number of the output connectors 3.

Further, as shown in FIG. 2, in an embodiment, the first housing 31 comprises at least two connected housing units 310. The two housing units 310 may be detachably connected together in a snap-fit connection, a magnetic connection, or the like, so as to facilitate maintenance and replacement of components in the first housing 31.

When the indicating device is the indicator light unit 4, the first housing 31 may also be provided with a light-transmitting portion. The light-transmitting portion can transmit light from the inside of the first housing 31. Further, in order to collect as much light as possible at the light-transmitting portion, the light-transmitting portion may be disposed right above the indicating device. It should be noted that “directly above the indicating device” is perpendicular to the extending direction of the cable body 1.

As shown in FIG. 3, in an embodiment, the light-transmitting portion is a light-transmitting hole 311, which penetrates through one surface of the first housing 31, so that the internal space of the first housing 31 is communicated with the outside air, and thus the light inside the first housing 31 can be observed by user through the light-transmitting hole 311. Of course, in other embodiments, at least a part of the first housing 31 may be made of a transparent material (e.g., glass, transparent plastic, etc.) to form the light-transmitting portion.

As shown in FIG. 3, in an embodiment, the charging cable also comprises a decorative member 5 capable of transmitting light. The decorative member 5 may be made of a transparent material such as glass, transparent plastic, or the like. At least a part of the decorative member 5 is disposed in the light-transmitting hole 311 to play a role of decoration and light transmission. Preferably, the shape and size of the light-transmitting hole 311 are matched with the shape and size of the decorative member 5. For example, in an embodiment, the decorative member 5 is shaped like a heart, and the light-transmitting hole 311 is also shaped like a heart. However, the decorative member 5 and/or the light-transmitting hole 311 may also be in other regular or irregular shapes, which are not limited by the present invention.

Further, in an embodiment, a part of the decoration member is disposed in the first housing 31, and the other part is disposed in the light-transmitting hole 311. As shown in FIG. 3 and FIG. 4, the part of the decorative member 5 located in the first housing 31 is provided with a fixing hole 50. The surface of the first housing 31 facing the indicating device (i.e., the inner wall surface of the first housing 31) is provided with a protrusion, and the protrusion on the first housing 31 is engaged with the fixing hole 50 on the decorative member 5, so as to fix the decorative member 5 relative to the first housing 31.

As shown in FIG. 2, in an embodiment, the input end further comprises a second housing 20 and a second circuit board 21. The two input connectors 2 and the cable body 1 are electrically connected to the second circuit board 21, respectively. Similar to the first housing 31, the second housing 20 may also comprise at least two connected subunit 201. The second housing 20 may be arranged with reference to the first housing 31, and is not described herein again.

As shown in FIG. 3 and FIG. 5, in an embodiment, one of the output connectors 3 of the output end is an Apple Lightning Dock connector with a Lightning plug, and the Lightning plug can be electrically connected to an Apple Lightning device externally and is connected to the first control circuit on the first circuit board 33. The other output connector 3 of the output end is a type-c connector, which has a type-c output end, and the type-c output end can be electrically connected to a type-c device externally, and is connected to the first control circuit on the first circuit board 33. The first control circuit is also connected to a current-voltage detection circuit 7.

As shown in FIG. 3 and FIG. 5, in an embodiment, one of the input connectors 2 of the input end is a Micro-USB connector, which has an A-male input end, and the A-male input end can be electrically connected to a USB-A interface charger externally, and is connected to the second control circuit on the second circuit board 21. The other input connector 2 of the input end is a type-c connector, which has a type-c input end, and the type-c input end can be electrically connected to a USB-C interface charger externally, and is connected to the second control circuit on the second circuit board 21.

As shown in FIG. 5, in an embodiment, the cable body 1 is a five-core cable connected between the current-voltage detection circuit 7 on the first circuit board 33 and the second control circuit on the second circuit board 21.

It can be understood that the above embodiments only express the preferred embodiments of the invention, and the description is more specific and detailed, but it cannot be understood as a limitation to the patent scope of the invention; It should be noted that, for those of ordinary skill in the art, the above technical features can be freely combined, and a number of modifications and improvements can be made without departing from the concept of the invention, all of which fall within the scope of protection of the invention. Therefore, all equivalent transformations and modifications made in the scope of the claims of the invention shall be covered by the claims of the invention.

What is claimed is:

1. A charging cable, comprising a longitudinal cable body (1), an input end and an output end electrically connected to two opposite ends of the cable body (1) respectively, wherein the output end comprises a first housing (31), a first circuit board (33), an indicating device for indicating a quick-charging state or a slow-charging state, and at least one output connector (3);
the indicating device and each output connector (3) are respectively connected to the first circuit board (33); the first circuit board (33) is electrically connected to the cable body (1); and the first housing (31) surrounds the first circuit board (33), the indicating device, and a portion of each output connector (3).

2. The charging cable according to claim 1, wherein the indicating device comprising an indicator light unit (4), and the indicator light unit (4) is used to indicate a quick-charging state or a slow-charging state.

3. The charging cable according to claim 2, wherein the indicator light unit (4) comprising a first indicator light (41) and a second indicator light (42) respectively connected to the first circuit board (33);
in the quick-charging state, the first indicator light (41) is turned on, and the second indicator light (42) is turned off;
in the slow-charging state, the second indicator light (42) is turned on, and the first indicator light (41) is turned off.

4. The charging cable according to claim 3, wherein, further comprising a light turning circuit (6) and a current-voltage detection circuit (7) electrically connected to the light turning circuit (6);
the light turning circuit (6) comprises a first light-emitting module (61) and a second light-emitting module (62), the first light-emitting module (61) comprises the first indicator light (41), and the second light-emitting module (62) comprises the second indicator light (42);
the current-voltage detection circuit (7) comprises a control chip (71), and the control chip (71) is respectively connected with the first light-emitting module (61) and the second light-emitting module (62).

5. The charging cable according to claim 1, wherein the first housing (31) is provided with at least one through hole, and all the output connector (3) and the cable body (1) respectively partially extend into the first housing (31) through the through hole.

6. The charging cable according to claim 1, wherein the first housing (31) is provided with a light-transmitting portion.

7. The charging cable according to claim 6, wherein the light-transmitting portion is a light-transmitting hole (311).

8. The charging cable according to claim 7, wherein the charging cable further comprises a decorative member (5) capable of transmitting light; and the decorative member (5) is partially arranged in the light-transmitting hole (311).

9. The charging cable according to claim 1, wherein the first housing (31) comprises at least two connected housing unit (310).

10. The charging cable according to claim 1, wherein the output connector (3) comprises at least one of a Micro-USB connector, a type-c connector and an Apple Lightning Dock connector.

11. The charging cable according to claim 2, wherein the output connector (3) comprises at least one of a Micro-USB connector, a type-c connector and an Apple Lightning Dock connector.

12. The charging cable according to claim 3, wherein the output connector (3) comprises at least one of a Micro-USB connector, a type-c connector and an Apple Lightning Dock connector.

13. The charging cable according to claim 4, wherein the output connector (3) comprises at least one of a Micro-USB connector, a type-c connector and an Apple Lightning Dock connector.

14. The charging cable according to claim 5, wherein the output connector (3) comprises at least one of a Micro-USB connector, a type-c connector and an Apple Lightning Dock connector.

15. The charging cable according to claim 6, wherein the output connector (3) comprises at least one of a Micro-USB connector, a type-c connector and an Apple Lightning Dock connector.

16. The charging cable according to claim 7, wherein the output connector (3) comprises at least one of a Micro-USB connector, a type-c connector and an Apple Lightning Dock connector.

17. The charging cable according to claim 8, wherein the output connector (3) comprises at least one of a Micro-USB connector, a type-c connector and an Apple Lightning Dock connector.

18. The charging cable according to claim 2, wherein the first housing (31) comprises at least two connected housing unit (310).

19. The charging cable according to claim 3, wherein the first housing (31) comprises at least two connected housing unit (310).

20. The charging cable according to claim 4, wherein the first housing (31) comprises at least two connected housing unit (310).
